(19) United States
(12) Patent Application Publication
(10) Pub. No.: US 2005/0231209 A1
(43) Pub. Date: Oct. 20, 2005

(54) Method and base chip for monitoring the operation of a microcontroller unit

(75) Inventors: Martin Wagner, Hamburg (DE); Matthias Muth, Stelle (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/517,471

(22) PCT Filed: Jun. 5, 2003
(86) PCT No.: PCT/IB03/02113

§ 371 Date: Dec. 7, 2004

(30) Foreign Application Priority Data
Jun. 10, 2002 (DE) 102 25 471.0

(51) Int. Cl. G06F 11/00

(52) U.S. Cl. 324/537; 714/1

(57) ABSTRACT

To further develop a method and a base chip (200) for monitoring the operation of at least one microcontroller that is intended for at least one application and is associated with a system (100) in such a way that a failure in the reset function can be reliably detected and the conclusions that need to be drawn for system-related reasons can be drawn, it is proposed that: the microcontroller unit (300) has at least one monitoring module (10) associated with it and that; the fact that a reset of the microcontroller unit (300) has taken place is acknowledged to the monitoring module (10) by means of at least one confirming signal.

The present invention relates to a method of monitoring the operation of at least one microcontroller unit that is intended for at least one application and is associated with a system.

The present invention further relates to a base chip, and particularly a system base chip, for monitoring the operation of at least one microcontroller unit that is intended for at least one application, and to an associated system, and particularly a control system.

One of the most important hardware signals in a control unit is the reset signal, the purpose of which is to reset the application hardware in the event of system faults. In certain applications, provision is even deliberately made by the user for the hardware to be reset, for example to enable parts of the program to be started in a microcontroller with the software in a set, ordered state.

However, as far as prescribed resetting is concerned, there is no feedback in existing applications on whether the resetting of the microcontroller has actually taken place or whether there is, say, a break in the reset line to the microcontroller. Hence, in the prior art, it is not possible for breaks of this kind in the reset line to be detected.

In this connection, even the so-called “watchdog” function that existing system chips have is powerless to help. If, for example, the system chip triggers a reset in ongoing operation but the reset signal in question fails to arrive at the microcontroller due to a break in the line, then the microcontroller will simply continue to operate the monitoring module (the so-called “watchdog” unit) in the system chip, and the software will continue running, as if there had not been any reset in this case. Consequently, the application software and the monitoring module will then be running out of synchronization with one another and there will no longer be any guarantee of the system being safe and reliable.

Taking the disadvantages and shortcomings described above as a point of departure and with due allowance for the prior art outlined, it is an object of the present invention so to further develop a method of the kind detailed in the first paragraph and a base chip of the kind detailed in the second paragraph that failure of the reset function is reliably detectable and the conclusions that need to be drawn for system-related reasons can be drawn.

This object is achieved by a method having the features specified in claim 1 and by a base chip having the features specified in claim 4. Advantageous embodiments and useful refinements of the present invention are described in the respective sets of dependent claims.

The present invention is therefore based on the microcontroller having at least one monitoring module associated with it; the fact that a reset of the microcontroller unit has taken place is acknowledged or signaled to this monitoring module by means of at least one confirming signal.

Under the teaching of the present invention, it is further proposed that at least one monitoring module be provided in the application, and in particular in at least one base chip and specifically in at least one S[ystem] B[ase] C[hip]. In accordance with the invention, there thus exists a system chip having a reset handshake, that is to say a means of acknowledgement for the reset function.

In a preferred embodiment of the present invention, it is proposed that different signals or different codes are used for triggering the watchdog monitoring module. As a function of the history that has led to a reset occurring, the application microcontroller must use different signals or different codes to confirm to the system chip that it has undergone a proper reset.

The normal cyclic access to the watchdog unit thus differs from an access after a reset event has taken place. Hence, if for example the system chip transmits a reset signal to the application, then the application must respond once with a special, differing signal or code. If it fails to do so, it can be assumed that there is a break in the reset line to the application or that the line is otherwise disrupted. The system chip may, for example, then go to a fail-safe mode in which current consumption is low.

In preferred embodiments of the present invention, there are in practice various possible ways of triggering a watchdog unit. In the simplest case, a hardware signal that has a pulse applied to it cyclically may be taken direct from the microcontroller unit to the watchdog unit. In more complex system chips on the other hand, use may be made of at least one serial interface unit to trigger the watchdog unit.

Regardless of the type of triggering, it is possible, in accordance with the invention, for distinctions to be made between the triggering events. When hardware signals are used, codings of the pulses may usefully be employed. The possibility also exists of switching a plurality of trigger signal lines. For system chips having a serial interface, one possibility that suggests itself is to use different serial words to distinguish between the watchdog accesses.

In accordance with the present invention, all the components required for developing a fail-safe system are available to the user. What is particularly advantageous is the flexibility of the present approach, because there are no fixed preset automatic functions that have to be incorporated in the S[ystem] B[ase] C[hip]. This allows the safety scheme for an application to be adapted and adjusted in the optimum manner and to be defined and/or scaled by the user in any desired way.

Finally, the present invention relates to the use of a method of the kind described above and/or of at least base chip of the kind described above for monitoring the operation of a microcontroller unit intended for at least one application, in automobile electronics and particularly in the electronics of motor vehicles.

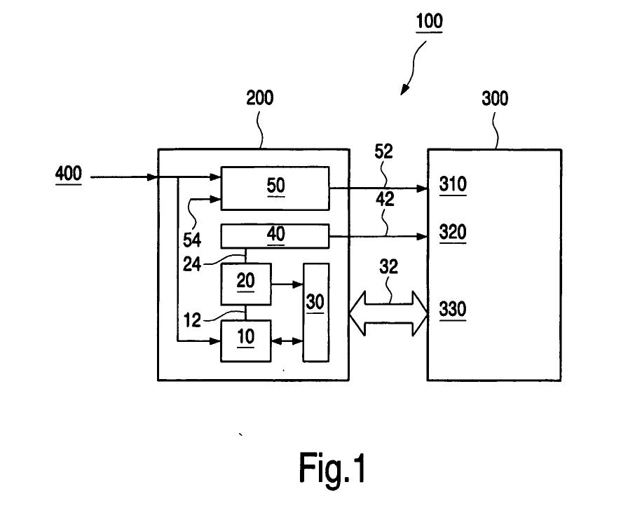

As has already been described above, there are various possible ways in which the teaching of the present invention may advantageously be embodied and refined. On the one hand, reference can be made in this connection in particular to the claims dependent on claims 1 and 4, and on the other, further aspects, features and advantages of the present invention are apparent from and will be elucidated with reference to the illustrative embodiment shown in FIG. 1 and described hereinafter.

In the drawings:

FIG. 1 is a block diagram of an embodiment of system according to the present invention having a base chip and a microcontroller unit.

Shown diagrammatically in FIG. 1 is a control system 100 that, as well as a microcontroller unit 300 having a supply unit 310 (providing the VDD supply), a reset unit 320 and an I[nput]/O[utput] module 330, also has a so-called S[ystem] B[ase] C[hip]) 200 for monitoring the operation of the microcontroller unit 300, the said microcontroller unit 300 being intended for an application.

For this purpose, the system chip 200 has, amongst other things, a monitoring module (=watchdog unit) 10 to which the fact that a reset of the microcontroller unit 300 has taken place can be acknowledged by means of a confirming signal, thus enabling a so-called “reset handshake” function to be implemented. In other words, what this means is that the watchdog unit 10, having emitted a reset command, receives a confirmation of the reset event from the application; in this way the monitoring module 10 shown in FIG. 1 makes it possible for broken reset lines 42 to be detected and logged.

In this connection, the system chip 200 supports a trigger signal that differs from normal operation or a trigger code that differs from normal operation to allow the success of the reset to be confirmed by the application. Consequently, failure of the reset function can be reliably detected and in particular it can be detected whether or not the reset signal for the application system was successfully received.

In the implementation shown in FIG. 1, provision may be made for the system chip 200 to permit a differing trigger signal only once after a reset command has been emitted. If the reset is not acknowledged once with the differing trigger signal or if the differing trigger signal is received without a prior reset, the system chip 200 goes to a fail-safe state to enable any potential further faulty behavior by the application to be prevented under any circumstances.

Because the system chip 200 permits a distinction to be made between different reset events and the events to be made accessible to the application microcontroller 300, the system chip 200 has an information unit 20 (for reset source information) that is provided to allow for different reset events and a reset unit 40 (for system resets) that is connected to the microcontroller unit 300 by a connection 42 (going to the reset unit 320 of the microcontroller unit 300).

To allow information and signals to be exchanged, the monitoring module 10 and the information unit 20 have inserted in front of them an interface unit 30 (feeding the I[nput]/O[utput] module 330 of the microcontroller unit 300).

As is also apparent from what is shown in FIG. 1, the monitoring module 10 and a microcontroller supply unit 50 that is connected to the microcontroller unit 300 by a connection 52 have permanently associated with them at least one battery unit 400. Whereas the monitoring module 10 receives a permanent supply from the battery 400, the microcontroller supply unit 50 can be switched on and off via a switch 54, thus enabling a temporary energy supply to be associated with the microcontroller unit 300 via the microcontroller supply unit 50 (supplying the VDD supply unit 310 of the microcontroller 300).

### LIST OF REFERENCE NUMERALS:

100 System, in particular a control system
10 Monitoring module, in particular a watchdog unit
12 Connection between monitoring module 10 and information unit 20
20 Information unit
24 Connection between information unit 20 and reset unit 40
30 Interface unit
32 Connection, particularly a signal line, between interface unit 30 and microcontroller unit 300
40 Reset unit
42 Connection between reset unit 40 and microcontroller unit 300
50 Supply unit
52 Connection between supply unit 50 and microcontroller unit 300
54 Switch of supply unit 50
200 Base chip, in particular system base chip
300 Microcontroller unit, in particular an application microcontroller
310 Supply unit for microcontroller unit 300
320 Reset unit for microcontroller unit 300
330 I[nput]/O[utput module of microcontroller unit 300
400 Battery unit

1. A method of monitoring the operation of at least one microcontroller unit (300) that is intended for at least one application and is associated with a system (100), characterized in that
the microcontroller unit (300) has at least one monitoring module (10) associated with it, and in that
the fact that a reset of the microcontroller unit (300) has taken place is acknowledged to the monitoring module (10) by means of at least one confirming signal.

2. A method as claimed in claim 1, characterized in that the confirming signal
is formed by at least one trigger signal or trigger code that differs from the normal operation of the microcontroller unit (300) and/or
is permitted only once by the monitoring module (10).

3. A method as claimed in claim 1 or 2, characterized in that,
in relation to the operation of the microcontroller unit (300), a distinction is made between different reset events and in that
these different reset events are acknowledged to the monitoring module (10) by means of different confirming signals.

4. A base chip (200), and particularly a system base chip, for monitoring the operation of at least one microcontroller unit (300) that is intended for at least one application, characterized by
at least one reset unit (40) connected (42) to the microcontroller unit (300), for resetting the microcontroller unit (300), and
at least one monitoring module (10) that is associated with the microcontroller unit (300) and to which the fact that a reset of the microcontroller unit (300) has taken place can be acknowledged by means of at least one confirming signal.

5. A base chip as claimed in claim 4, characterized by
at least one information unit (20) that is provided to allow for different reset events, and
at least one supply unit (50) that is connected (52) to the microcontroller unit (300).

6. A base chip as claimed in claim 4 or 5, characterized in that
the monitoring module (10) can be triggered by means of at least one interface unit (30) and/or in that,
to distinguish between the individual accesses to the monitoring module (10), different reset events can be marked by different trigger values.

7. A base chip as claimed in any of claims 4 to 6, characterized in that the base chip (200) goes to a fail-safe mode
if the resetting of the microcontroller unit (300) is not acknowledged once by means of the confirming signal and/or
if the base chip (200) receives the confirming signal without a reset having taken place previously,
there being, in the fail-safe mode, in particular a current consumption that is lower than in normal operation.

8. A base chip as claimed in any of claims 4 to 7, characterized in that there is provided between the monitoring module (10) and the microcontroller unit (300) at least one signal line (32) for transmitting the confirming signal, and in particular the trigger signal or trigger code that differs from the normal operation of the microcontroller unit (300).

9. A system (100), and particularly a control system, characterized by at least one microcontroller unit (300) intended for at least one application and by at least one base chip (200) as claimed in any of claims 4 to 8.

10. Use of a method as claimed in any of claims 1 to 3 and/or of at least one base chip (200) as claimed in any of claims 4 to 8 for monitoring the operation of at least one microcontroller unit (300) intended for at least one application, in automobile electronics and in particular in the electronics of motor vehicles.
